(19) United States
(12) Patent Application Publication
(10) Pub. No.: US 2003/0071434 A1
(43) Pub. Date: Apr. 17, 2003

(54) Dual function passenger access system for a vehicle

(76) Inventor: Alfred L. Budd, Winamac, IN (US)

Correspondence Address: Perry J. Hoffman, Esq., Michael Best & Friedrich LLC, 401 North Michigan Ave., Suite 1900, Chicago, IL, 60611, US

(21) Appl. No.: 09/978,499

(22) Filed: Oct. 16, 2001

(51) Int. Cl. B60R 3/00; B60R 3/02

(52) U.S. Cl. 280/166

(57) ABSTRACT

There is provided a passenger access system that includes a pedestrian access system for pedestrian ingress and egress through a vehicle door opening that can be used alone or in combination with a wheelchair access system. The pedestrian access system includes a step assembly mounted in a housing secured under a vehicle at a door opening. The step assembly is movable between a stowed position in the housing and deployed positions wherein pedestrians can step on the step assembly to access the vehicle through the door opening.

### BACKGROUND OF THE INVENTION

The present invention relates generally to the field of passenger access systems for vehicles, and more particularly to passenger access systems which provide access to vehicles for wheelchair passengers and/or pedestrian passengers.

Wheelchair access systems have been provided for wheelchair access to a vehicle through a door opening of the vehicle. Such wheelchair access systems can provide a transfer member in the form of either a lift or ramp that allows the wheelchair bound person to ingress and egress between the vehicle and the curb or ground. Various wheelchair access systems have also been designed in order to provide a generally unobstructed doorway for pedestrian ingress and egress to and from the vehicle when the wheelchair access system is not in use.

While pedestrians do not face the same obstacles in accessing vehicles as do wheelchair bound persons, it is still desirable to assist the ingress and egress of pedestrians between the vehicle and the curb or the ground. For example, the vehicle door opening may be at a height above the ground that makes it difficult and possibly unsafe for the pedestrian to ingress or egress the vehicle through the door opening. It can be desirable to provide such ingress and egress assistance to pedestrians whether or not there is a wheelchair access system at the vehicle door opening.

### SUMMARY OF THE INVENTION

The present invention is directed toward providing a passenger access system that includes a pedestrian access system for pedestrian ingress and egress through a vehicle door opening. The pedestrian access system can be used alone or in combination with a wheelchair access system.

In one form, the pedestrian access system includes a step assembly mounted under a vehicle at a door opening. The step assembly is movable in either of a powered or manual mode, or in combinations of powered and manual modes, between a stowed position and one or more deployed positions wherein pedestrians can step on the step assembly to access the vehicle through the door opening. If the pedestrian access system is employed in combination with a wheelchair access system, it is contemplated that the wheelchair access system can be of a type that maintains the vehicle door opening in a substantially unobstructed state when the wheelchair access system is in a stowed position.

Aspects, forms, embodiments, objects, advantages and features of the present invention will also be apparent from the following description of the illustrated embodiment.

### BRIEF DESCRIPTION OF THE DRAWINGS

FIG. 1 is perspective view of a passenger access system for a vehicle according to the present invention that includes a wheelchair access system and a pedestrian access system.

FIG. 2 is a perspective view of the pedestrian access system according to the present invention in a stowed position.

FIG. 3 is a perspective view of the pedestrian access system of FIG. 2 in a first deployed position.

FIG. 4 is a perspective view of the pedestrian access system of FIG. 2 in a second deployed position.

FIG. 5 is an exploded perspective view of the pedestrian access system of FIG. 2.

FIG. 6 is an exploded perspective view of a step assembly comprising a portion of the pedestrian access system of FIG. 2.

FIG. 7 is an exploded perspective view of the drive systems for the pedestrian access system of FIG. 2 with only a portion of the upper step shown and broken away to reveal the drive systems.

FIG. 8 is a perspective view of various control devices mounted to the upper step of the pedestrian access system of FIG. 2 with only a portion of the upper step shown and broken away to reveal the control devices.

### DESCRIPTION OF THE ILLUSTRATED EMBODIMENT

For the purposes of promoting an understanding of the principles of the invention, reference will now be made to the embodiment illustrated in the drawings and specific language will be used to describe the same. It will nevertheless be understood that no limitation of the scope of the invention is thereby intended. Any such alterations and further modifications in the illustrated embodiment, and any such further applications of the principles of the invention as illustrated herein are contemplated as would normally occur to one skilled in the art to which the invention relates.

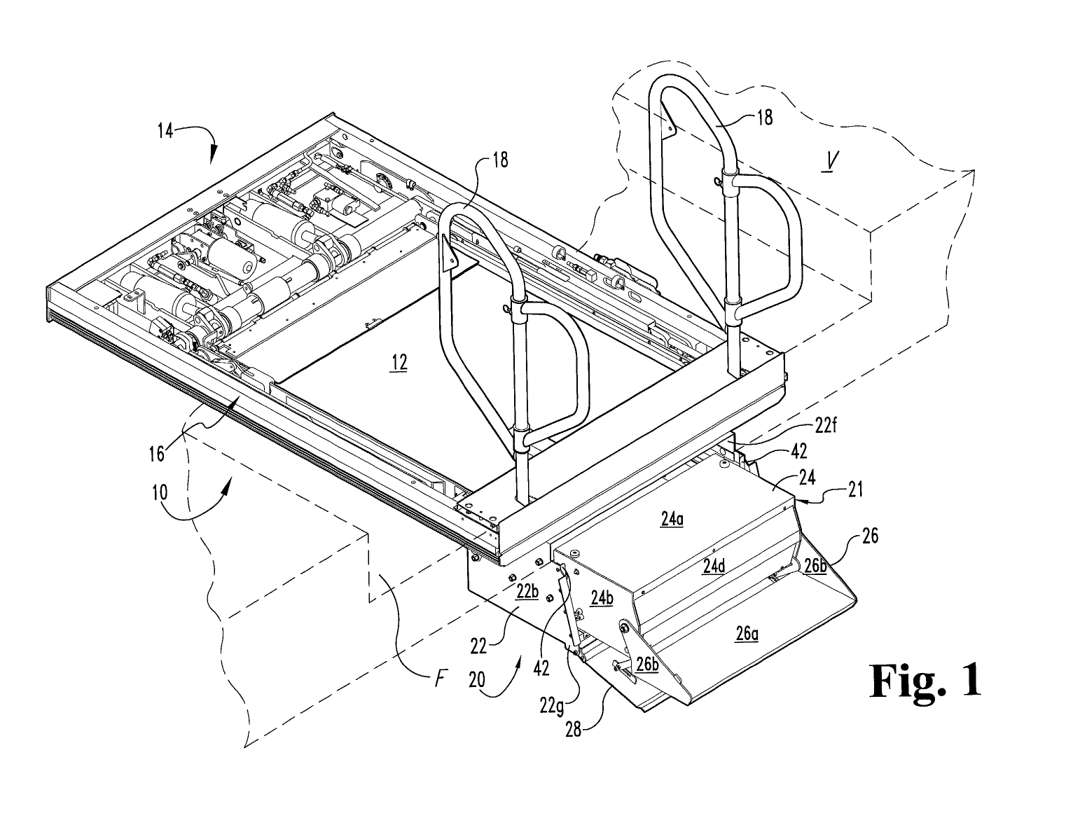

Referring now to FIG. 1, there is shown a passenger access system for a vehicle V that includes a wheelchair access system 10 and a pedestrian access system 20. Vehicle V can be a van, truck, bus, trolley, train or any other vehicle for transporting passengers. Wheelchair access system 10 can be mounted to vehicle V on or below floor F at an opening that provides access to the vehicle. It is contemplated that the opening could be provided with or without a door. Wheelchair access system 10 includes a transfer member 12, a drive system 14 coupled to transfer member 12, and a frame 16 in which drive system 14 and transfer member 12 reside. Transfer member 12 is movable between a stowed position, such as shown in FIG. 1, to a deployed position in which transfer member 12 extends outwardly from vehicle V at the opening. A cover plate (not shown) covers drive system 14 in frame 16.

In FIG. 1 wheelchair access system 10 is a wheelchair lift in which transfer member 12 is deployed in a substantial horizontal position from vehicle V at floor level F. A wheelchair passenger may then position the wheelchair on transfer member 12 to egress the vehicle, and drive system 14 is operable to lower transfer member 12 with the wheelchair thereon to the ground level. Transfer member 12 can also be raised from its ground level position to the deployed horizontal position with a wheelchair thereon to provide wheelchair ingress to the vehicle. Wheelchair access system 10 can further include a pair of safety barriers 18 on either side thereof which prevent wheelchair and pedestrian passengers from exiting vehicle V until either transfer member 12 or step assembly 21 is properly deployed. Examples of such safety barriers are provided in U.S. Pat. No. 6,077,025, which is incorporated herein by reference in its entirety.

It is contemplated that wheelchair access system 10 is configured such that the door opening is substantially unobstructed when the wheelchair access system 10 is not in use or in its stowed position. Examples of such wheelchair access systems include lifts and ramps that are located between the floor and the frame of the vehicle, or below the frame of the vehicle. Other examples include ramps and lifts that are foldable and/or movable to create an at least partially unobstructed opening for pedestrian access. Further examples of such wheelchair access systems are the UFLM™ 1000 Under Floor Wheelchair Lift and the Under-Vehicle Lift®, each of which are manufactured and sold by the Braun Corporation. Further examples of wheelchair access systems are provided in U.S. Pat. Nos. 5,975,830 and 5,672,041, each of which are incorporated by reference herein in their entirety.

Pedestrian access system 20 includes a housing 22 secured to the vehicle below the opening. In the embodiment illustrated in FIG. 1, frame 16 and housing 22 are each secured to the body of the vehicle below wheelchair access system 10. Other embodiments contemplate that housing 22 is secured directly to the vehicle floor, to a portion of wheelchair access system 10, or to the vehicle frame. Housing 22 can also be offset to one side of wheelchair access system 10, so long as pedestrian access system 20 is located to provide pedestrian ingress and egress to vehicle V through the opening. It is also contemplated pedestrian access system 20 can be employed on vehicle V without a wheelchair access system 10.

Pedestrian access system 20 includes a step assembly 21 mounted to housing 22. Step assembly 21 includes a first upper step 24 and second lower step 26. Housing 22 defines a cavity that is sized to receive step assembly 21 when it is in its stowed position as described further below. Pedestrian access system 20 further includes a door 28 pivotally connected to flanges 22g located at the bottom of housing 22. As step assembly 12 is moved to its stowed position, door 28 pivots about its connection with housing 22 to a substantially vertical position against front opening 22f of housing 22 to conceal step assembly 21 in housing 22.

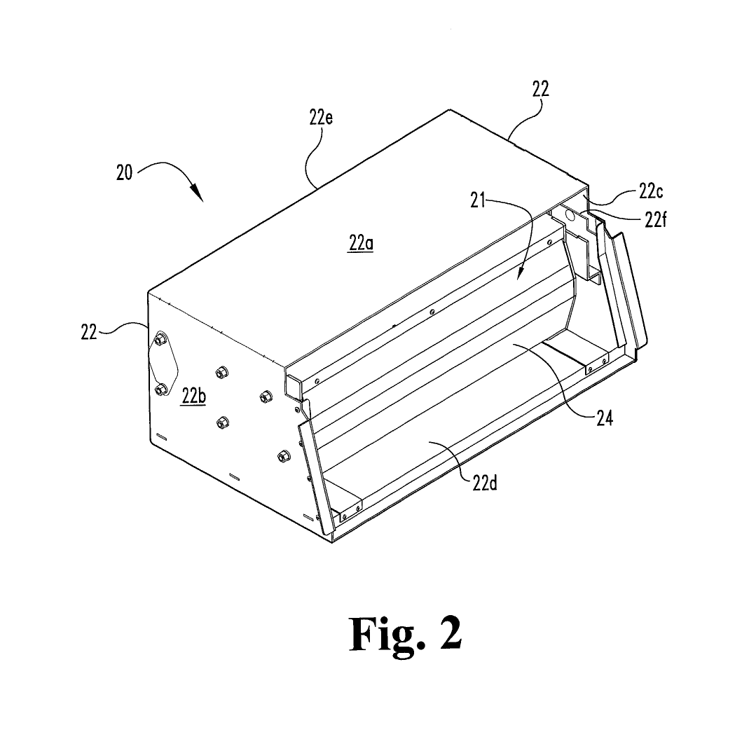

Referring now to FIGS. 2-4, further details regarding pedestrian access system 20 will be discussed. Door 28 has been removed in FIGS. 2-4, it being understood that door 28 can be provided as shown in FIG. 1 and as discussed further below. Housing 22 includes a top wall 22a, a pair of opposite sidewalls 22b, 22b, and a bottom wall 22d defining the cavity which receives step assembly 21. Housing 22 can be further provided with a rear opening 22e and an opposite front opening 22f facing outwardly of the vehicle. In FIG. 2, step assembly 21 is showed in a stowed position within the cavity defined by housing 22. Bottom wall 22d supports step assembly 21 in housing 22.

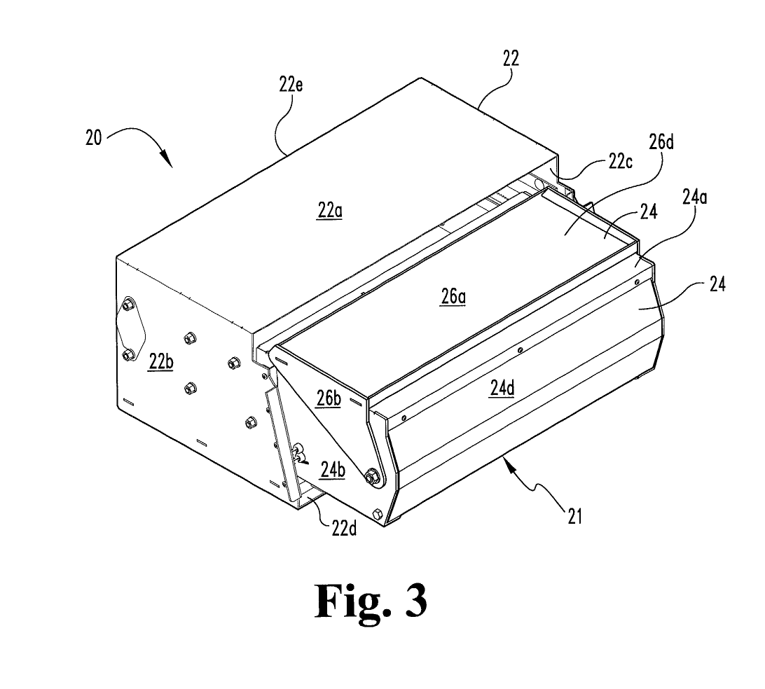

In FIG. 3, step assembly 21 has been moved with respect to housing 22 to its first deployed position. First step 24 includes a first step member 24a and a front wall 24d extending therealong. First step 24 further includes opposite sidewalls 24b and 24c extending along the sides of first step member 24a. First step member 24a, sidewalls 24b, 24c and front wall 24d define a cavity in which drive assemblies are located, as described more fully below, for moving step assembly 21 between its stowed position and deployed positions. First step member 24a also has an upwardly facing tread surface 24e.

Second step 26 includes a second step member 26a and a pair of opposite side flanges 26b, 26c extending along second step member 26a. Second step member 26a includes a first tread surface 26d and an opposite second tread surface 26e. Side flanges 26b, 26c are pivotally coupled to sidewalls 24b, 24c of first step member 24a so that second step 26 can pivot with respect to first step 24.

A first deployed position for step assembly 21 is shown in FIG. 3. First tread surface 26d of second step member 26a is positioned adjacent to tread surface 24e of first step member 24a, and second tread surface 26e of second step member 26a faces upwardly. In this first deployed position, a pedestrian may step on second tread surface 26e of second step 26, which is supported on first step 24, and then into vehicle V through the door opening.

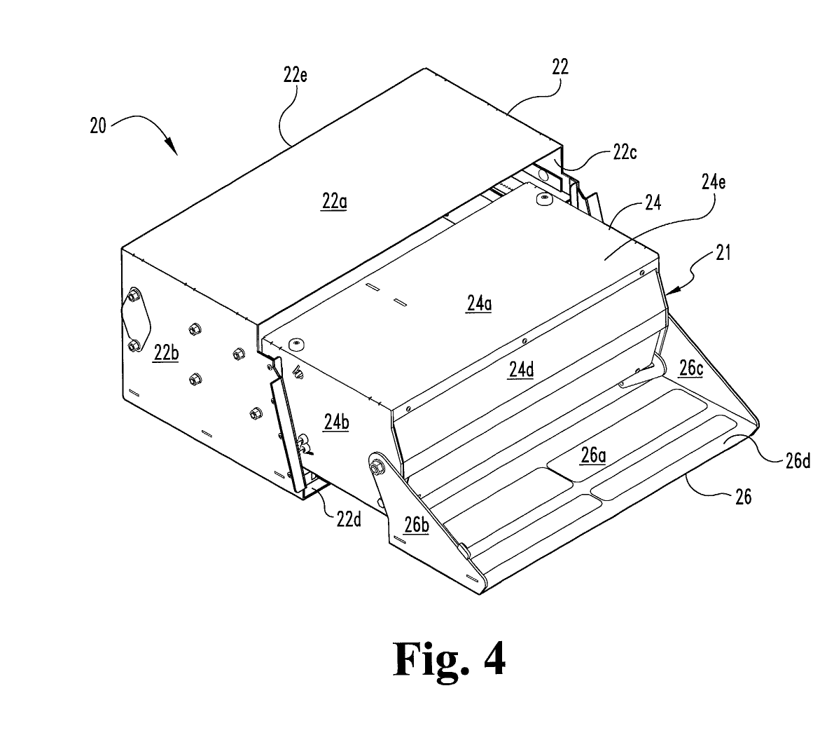

A second deployed position for step assembly 21 is shown in FIG. 4. Second step 26 has been pivoted with respect to first step 24 so that first tread surface 26d faces upwardly and second tread surface 26e faces downwardly. First and second tread surfaces 26d, 26e and tread surface 24e can each include roughenings to reduce slippage. In the second deployed position, a pedestrian may step on first tread surface 26d of second step member 26a, and then step on tread surface 24e of first step member 24a, and then into the vehicle V. Front wall 24d conceals the cavity defined by first step 24 and prevents the pedestrian from tripping on first step member 24a. Sidewalls 22b, 22c of housing 22 extend forwardly at their bottom a greater distance than they do at the top of housing 22, forming a cantilevered support that helps support step assembly 21 on housing 22 when step assembly 21 is in its deployed positions.

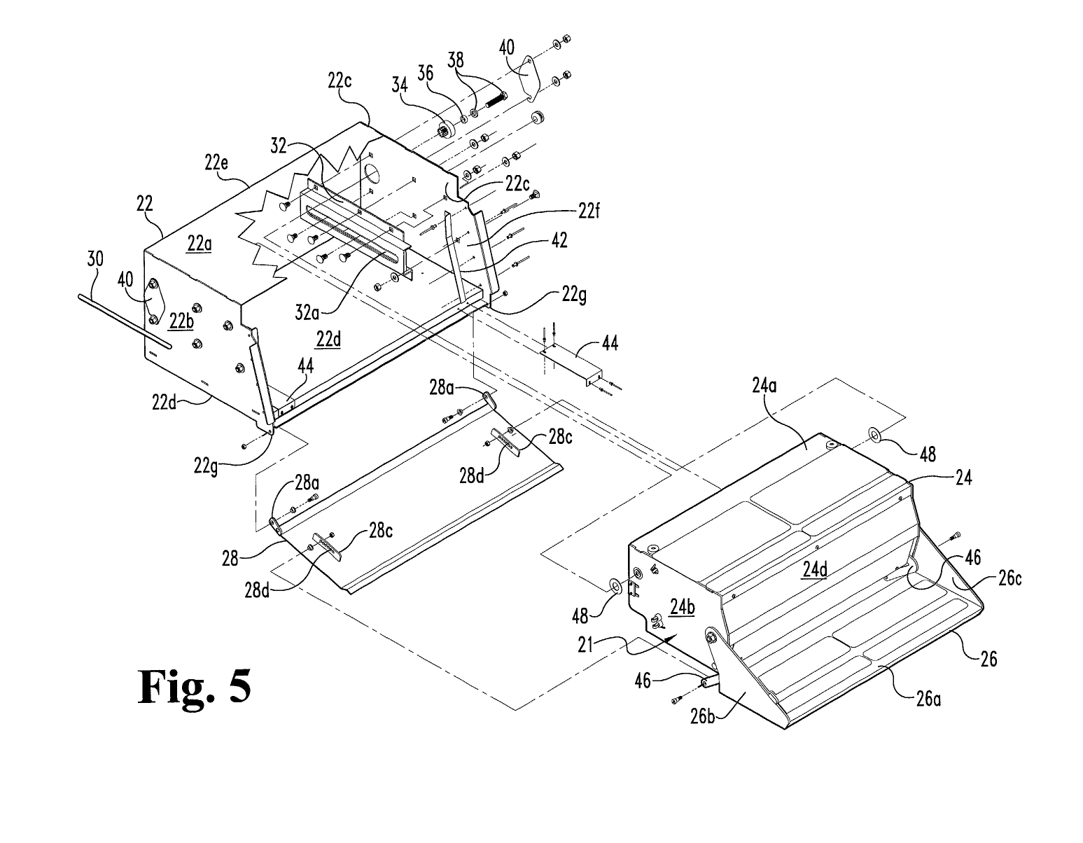

Referring now to FIGS. 5-7, further details of pedestrian access system 20 will be described. A stabilization bar 30 extends between sidewall 22b of housing 22 and the vehicle structure to which housing 22 is mounted. A second stabilization bar can be provided extending from sidewall 22c. Stabilization bars 30 stabilize housing 22 to the vehicle and assist in resisting lateral sway of housing 22.

Housing 22 also includes a track 32 mounted on inner side of sidewall 22c. An identical track (not shown) is provided on sidewall 22b. Track 32 includes a track slot 32a extending therealong in the direction between front opening 22f and rear opening 22e. Housing 22 includes lower flanges 22g at the outer end of housing 22 at the junctions between bottom wall 22d and sidewalls 22b, 22c. Door 28 is pivotally coupled to lower flanges 28a. Housing 22 further includes jams 42 extending along the inner side of each sidewall 22b, 22c near front opening 22f of housing 22. Door 28 abuts against jams 42 when it is closed to close front opening 22f and conceal step assembly 21 in housing 22.

First step member 24 is mounted in tracks 32 of housing 22 and movable therealong to extend and retract step assembly 21 with respect to housing 22. Movement of step assembly 21 in an automatic mode is accomplished by a first drive motor assembly housed in first step 24. First step 24 includes a first drive motor 68 engaged to an axle 78 mounted in first step 24. Gear adapters 34 in the form of wheels or other driving member are mounted on opposite ends of axle 78, and gear adapters 34 are positioned in respective ones of the track slots 32a of tracks 32. Gear adapters 34 rotate in their respective slot 32a to move step assembly 21 along tracks 32. In one form, gear adapters 34 have teeth therealong that interdigitate with teeth formed along the track slots 32a.

Axle 78 extends through sidewalls 24b, 24c of first step 24. Collars 82 are positioned on axle 78 along the inside of sidewalls 24b, 24c. Set screws secure collars 82 to axle 78 to maintain the positioning of the ends of axle 78 extending through sidewalls 24b, 24c. Bearing flanges 84 are positioned on the outside of sidewalls 24b, 24c around respective ends of axle 78. Washers 48 are positioned around respective ends of axle 78 and against respective ones of the bearing flanges 84, which space washers 48 away from sidewalls 24b, 24c. Washers 48 are positioned along the inner side of the adjacent track 32. To engage each gear adapter 34 to its respective end of axle 78, a fastener assembly 38 is provided that includes a fastener extending through spacer 36 and gear adapter 34 into hollow threaded ends of axle 78. Gear adapters 34 move along track slots 32a to move step assembly 21 between its stowed position in housing 22 and its first deployed position. A cover 40 can be secured to each sidewall 22b, 22c of housing 22 to cover holes provided in sidewalls 22b, 22c for assembly of gear adapters 34 to axle 78.

First step 24 further includes a mounting member 64 between first sidewall 24b and second sidewall 24c. First drive motor 68 is coupled to a first sprocket adapter 72, and first drive motor 68 and sprocket adapter 72 are mounted to member 64 via spacers 76 and various fasteners. Sprocket 98 is positioned around axle 78 and engaged to second sprocket adapter 72 by a chain (not shown) extending therearound to drive axle 78 in either rotational directions. Washer 100 and bearing flange 102 are positioned around axle 78 and space sprocket 98 from the inner side of sidewall 24b.

A collar 96 is secured to axle 78 with a set screw on the side of sprocket 98 opposite washer 100 and bearing flange 102. Collar 96 maintains the position of sprocket 98 on axle 78 against washer 100. A lock nut 92 is formed at the end of lock pin hub 94, and lock pin hub 94 is positioned around axle 78 and keyed thereto with key 86. A locking spring 80 normally biases lock pins 94a, 94b of lock pin hub 94 around collar 96 and into engagement with receiving holes formed in sprocket 98. With lock pin hub 94 engaged to sprocket 98, step assembly 21 cannot be manually moved from its first deployed position into housing 22 since the first drive motor acts as a brake to prevent axle 78 from rotating except by action of first drive motor 68.

Step assembly 21 can also be operated in a manual mode. A manual release mechanism 99 is operable to withdraw locking pins 94a, 94b out of engagement with sprocket 98 by displacing lock pin hub 94 along axle 78. With lock pins 94a, 94b in this position, axle 78 is uncoupled from sprocket 98 and first drive motor 68, and axle 78 can freely rotate in sprocket 98 for manually pushing step assembly 21 back into or out of housing 22 in case of drive motor failure.

Manual release mechanism 99 includes a sheathed cable 104 extending through mounting member 64 where it is engaged to actuator 88. A cable mount plate 106 bears against mounting member 64, and supports handle 108 thereon. Handle 108 is accessible through the rear opening of housing 22 and first step 24. A cable retainer clamp 90 secures the end of cable 104 to one end of actuator 88. A jam nut 110 engages cable retainer clamp 90 to the end of cable 104. Actuator 88 is pivotally mounted at one end to mounting bracket 64a of mounting member 64, and has an opposite forked end extending around and coupled to lock pin hub 94. When an operator pulls on handle 108, actuator 88 pivots with respect to mounting bracket 64a so that the forked end pushes on lock nut 92 and against the spring compression force of spring 80, displacing lock pin hub 94. This releases lock pins 94a, 94b from holes 98a, 98b of sprocket 98 and allows axle 78 to rotate in sprocket 98. Handle 108 can be provided with a locking mechanism that maintains it in the pulled position during manual movement of step assembly 21. When the handle is released, locking spring 80 pushes lock pins 94a, 94b into engagement with holes 98a, 98b of sprocket 98.

Door 28 is pivotally coupled to first step 24 to ends 46b of linkages 46. Ends 46a of linkages 46 are also pivotally coupled to linkage brackets 28c on the inner side of door 28. Linkage brackets 28c have slots 28d formed therealong which allow the coupling location between linkages 46 and brackets 28c to be adjusted for proper fit of door 28 against jams 42 in opening 22f of housing 22.

First step member 24a of first step 24 includes bumpers 50 made of a rubber-like or other cushioning material on tread surface 24e to support second step member 26a on first step member 24a. First step 24 can further include bottom roller brackets 24e. Roller brackets 24e include holes 24f formed therethrough through rollers 56 are positioned. Rollers 56 rest upon bottom wall 22d of housing 22 and facilitate the travel of step assembly 21 along bottom wall 22d. Bottom wall 22d of housing 22 includes skid plates 44 to reinforce bottom wall 22d along the locations where rollers 56 of step assembly 21 contact bottom wall 22d as step assembly 21 is moved between its stowed position and its first deployed position.

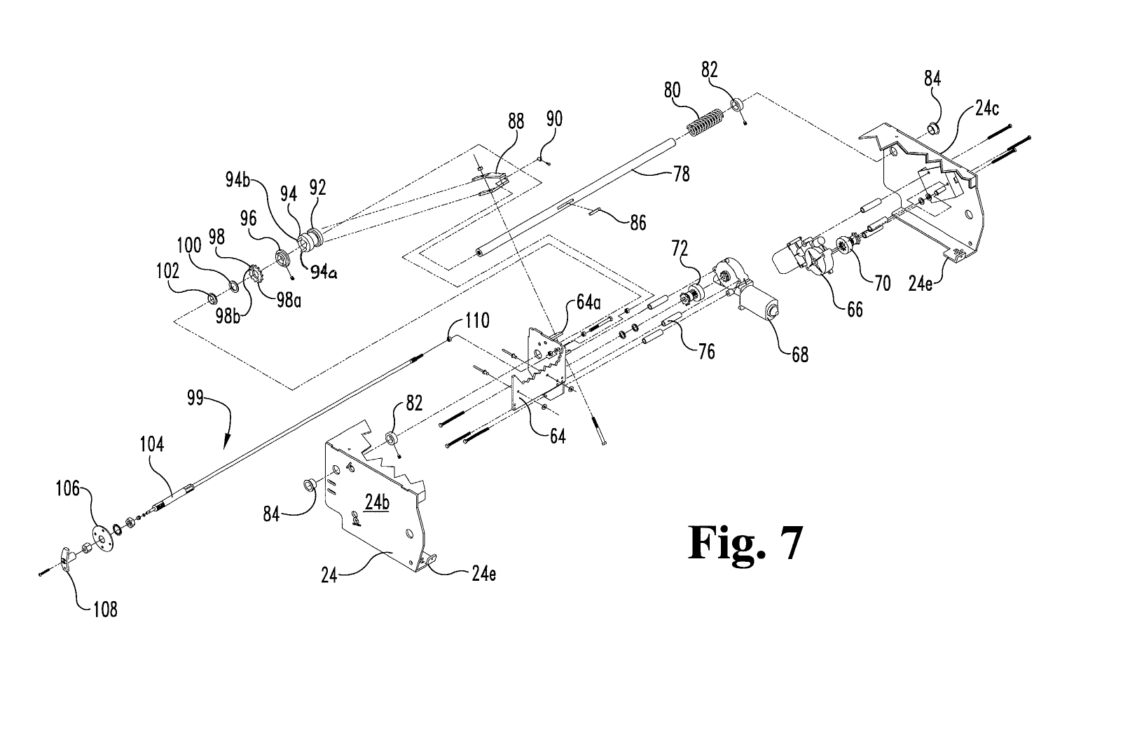

A second drive motor assembly is provided to pivot second step 26 from the first deployed position of FIG. 3 to the second deployed position of FIG. 4 and back. The second drive motor assembly is housed in first step 24 and includes a shaft 60 coupled to a clutch sprocket 58 with key 62. Shaft 60 is coupled to side flange 26c of second step 26. As shown in FIG. 7, a second drive motor 66 is coupled to a sprocket adapter 70 which is engaged to sprocket 58 via a chain (not shown) extending therearound. Second drive motor 66 and sprocket adapter 70 are coupled to sidewall 24c of second step 24 and spaced therefrom with spacers 74. Second drive motor 66 drives first sprocket adapter 70 and thus clutch sprocket 58 and shaft 60 in a first rotational direction in order to pivot second step 26 from its first deployed position of FIG. 3 to its second deployed position of FIG. 4. Second drive motor 66 is reversible to drive sprocket adapter 70 and thus clutch sprocket 58 and shaft 60 in the opposite rotational direction to move second step 26 from its deployed position of FIG. 4 to its first deployed position of FIG. 3.

Second step 26 is clutched to the first drive assembly by clutch sprocket 58. Thus, in addition to having an automatic mode where second step 26 is pivoted by operation of second driver motor 66, second step 26 simultaneously includes a manual mode that provides manually pivoting of second step 26 with respect to first step 24 between the first deployed position and the second deployed position. Other embodiments contemplate that second step 26 is not manually pivotable unless released by a release mechanism such as discussed above with respect to manual release mechanism 99.

Techniques for manually stowing and deploying the step assembly of the present invention will now be discussed. In a first scenario the first drive assembly is inoperable and step assembly 21 is stowed in housing 22. Manual release mechanism 99 is actuated to uncouple axle 78 from sprocket 98. In this manual mode, the operator can then manually pull on door 28 to pivot it downwardly to the position shown in FIG. 1. As door 28 is moved downwardly, linkages 46 pull step assembly 21 out of housing 22 to the first deployed position. Second step 26 can then be manually pivoted about first step 24 to the second deployed position if desired. To stow step assembly 21, second step 26, if necessary, is pivoted manually from the second deployed position to the first deployed position. Step assembly 21 is then manually pushed a portion of the way into housing 22 in order to move step assembly 21 toward the vehicle and past the center of door 28. Door 28 can then be manually pushed toward housing 28, and linkages 46 act on step assembly 21 to move it to its stowed position in housing 22 as door 28 is closed.

In a second scenario the second drive assembly is either inoperable or it is simply not desirable or convenient to operate second drive motor 66. Step assembly 21 is stowed in housing 22. Step assembly 21 is moved to its first deployed position with the operation of first drive motor 68. Second step 26 can then be manually pivoted about first step 24 to the second deployed position if desired. To stow step assembly 21, second step 26 is pivoted manually from the second deployed position to the first deployed position. Step assembly 21 is then automatically moved from the first deployed position to its stowed position in housing 22 with first drive motor 68.

Also contemplated are scenarios in which step assembly 21 has been automatically deployed to one of its first or second deployed positions, and then either or both of the drive motors do not function properly. The deployed step assembly 21 can then be manually stowed into housing 22 using the techniques discussed above.

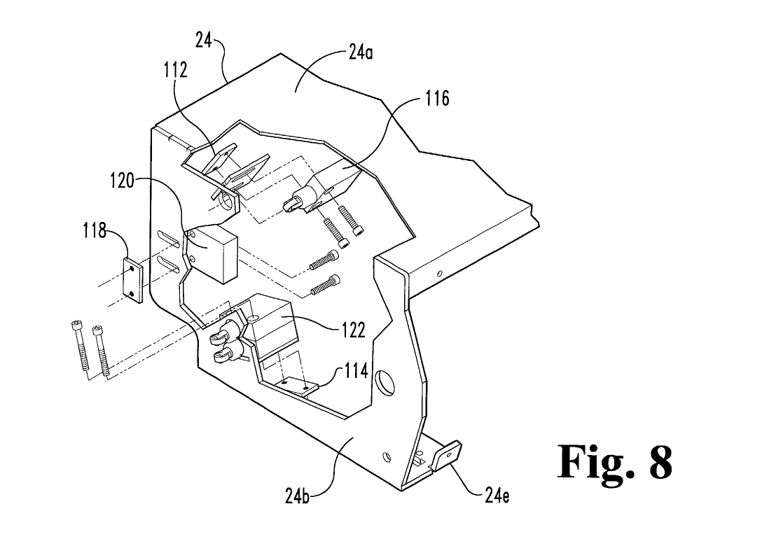

Referring now to FIG. 8 there is shown various switches mounted to step assembly 21 or control operation of pedestrian access system 20. A step assembly stow switch 120 is adjustably mounted in slots in sidewall 24b with plate 118. Step assembly stow switch 120 contacts a wall or flange positioned at the rear 22e of housing 22 in order to provide a signal deactivating first drive motor operation stowing step assembly 21 in housing 22. The slots allow the location of switch 120 to be adjusted. A step assembly deploy switch 122 is mounted on a slotted bracket via plate 114 and has a pair of contacts extending through sidewall 24b of first step 24 and contacting the inner side of sidewall 22b of housing 22. When step assembly 21 is extended from housing 22 a sufficient distance, step assembly deploy switch 22 no longer contacts sidewall 22b, and a signal is provided to deactivate the first drive motor operation deploying step assembly 21.

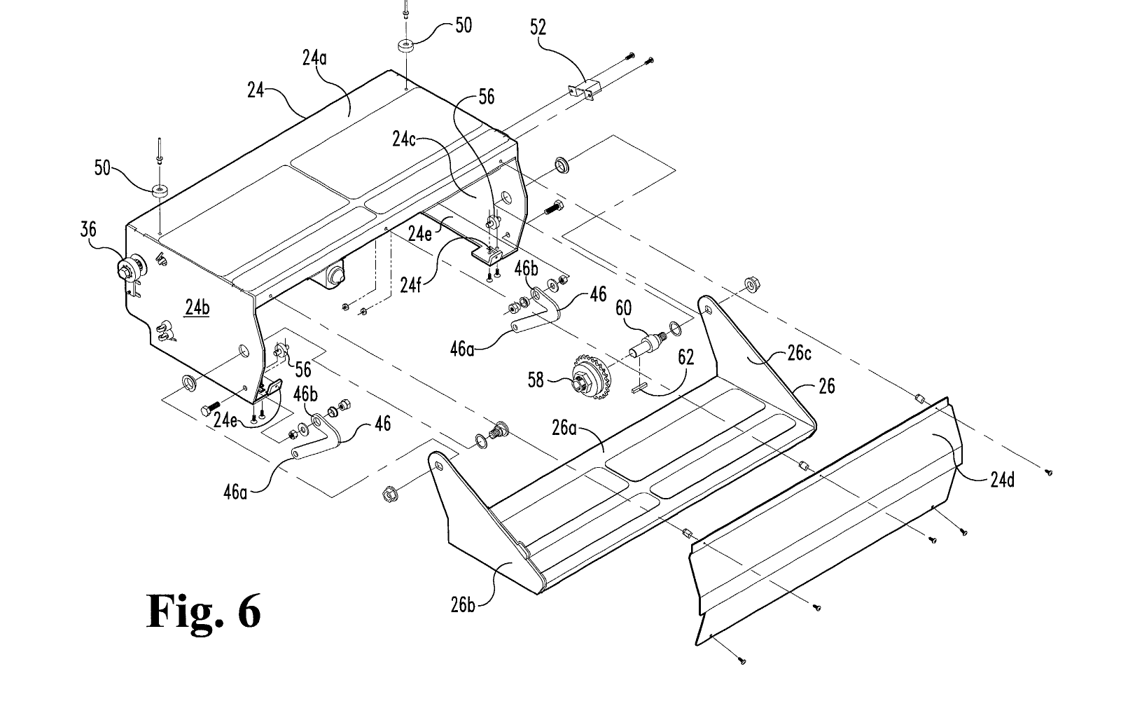

A second step stow switch 116 is adjustably mounted in slots of a bracket by plate 112. Second step stow switch 116 has a contact extending through sidewall 24b. As second step 26 is moved from the second deployed position to the first deployed position, second step stow switch contacts side flange 26b of second step 26 when second step 26 is pivoted onto first step 24, deactivating operation of the second drive motor. Similarly, a second step deploy switch 52 (FIG. 6) can be adjustably mounted on sidewall 24c of first step 24. Second step deploy switch 52 is contacted by side flange 26c of second step 26 when second step 26 is moved to its second deployed position, providing a signal deactivating operation of the second drive motor when second step 26 is in its second deployed position.

Description of one mode of operation of the systems of the present invention will now be described. It should be understood, however, that modes other than those described herein are also contemplated. In order to operate the wheelchair access system 10 or pedestrian access system 20, the vehicle interlock must be activated. The vehicle interlock requires the vehicle to be in its parking gear, the emergency brake to be set, the switch for access system 10 to be turned on, the ignition key to be turned on and the vehicle doors opened at the location of access system 10. The vehicle interlock also prevents the vehicle from being moved out of the parking gear while either the wheelchair access system 10 or pedestrian access system 20 is operable.

In order to operate pedestrian access assembly 20, wheelchair access system 10 must be fully stowed within the vehicle and in its proper stowed position. Step assembly 21 can then be deployed from housing 22 by activating an out function on a controller. Once the step assembly is deployed to its first deployed position, first step 26 can be further deployed to its second deployed position if needed due to the height of the vehicle door opening above the ground. Deployment to the second deployed position can be activated by a controller function. In order to stow the pedestrian access assembly 10, a stow function on the controller can be activated. Depending upon the state of deployment of the step assembly 21, second step 26 can be pivoted onto first step 24, and then step assembly 21 retracted into housing 22. It is further contemplated that step assembly 21 must be fully stowed in order operate wheelchair access system 10.

In an alternate form, if transfer member 12 of wheelchair access system 10 were deployed from the vehicle, and the operator activates a step assembly deploy switch for pedestrian access system 20, transfer member 12 automatically stows in frame 16 before step assembly 21 is deployed from housing 22. Further, if step assembly 21 were deployed, and the transfer member deploy switch were activated by an operator, step assembly 21 would stow into housing 22 before deployment of transfer member 12 of wheelchair access system 10.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

What is claimed is:

1. A passenger access system at an opening of a vehicle, comprising:
a wheelchair access system having a transfer member movable between a stowed position whereby the opening is substantially unobstructed and a deployed position extending from the vehicle at the opening;
a pedestrian access system including a step assembly mounted to the vehicle and stowed below the opening, said step assembly movable to a deployed position extending from the vehicle below the opening when said transfer member is in its stowed position.

2. The passenger access system of claim 1, wherein said pedestrian access system includes a housing.

3. The passenger access system of claim 2, wherein:
said housing includes a pair of opposite sidewalls, each of said sidewalls having a track on an inner side thereof; and
said step assembly includes a pair of drive wheels, each of said drive wheels positioned in a respective one of said tracks, said drive wheels movable along said tracks to move said step assembly to said deployed position.

4. The passenger access system of claim 2, further comprising a door pivotally coupled to a lower portion of said housing and at least one linkage coupling said door to said step assembly, wherein said door has a substantially vertical position concealing said step assembly in said housing and is movable to an open position below said step assembly by said linkage as said step assembly is moved to said deployed position.

5. The passenger access system of claim 1, wherein said wheelchair access system is located under a floor of the vehicle.

6. The passenger access system of claim 1, wherein said step assembly includes a first step and a second step.

7. The passenger access system of claim 6, wherein said second step is pivotally mounted to an outboard end of said first step.

8. The passenger access system of claim 6, wherein said step assembly has a first deployed position wherein said second step is supported on said first step and a second deployed position wherein said second step is below said first step and extends from said first step away from the vehicle.

9. The passenger access system of claim 8, wherein said pedestrian access system includes a first drive system for moving said step assembly to said first deployed position and a second drive system for moving said second step to said second deployed position.

10. The passenger access system of claim 9, wherein:
said step assembly is stowed in a housing, said housing including a pair of opposite sidewalls each having a track therealong;
said first drive system includes a first motor coupled to an axle, said axle secured to said first step and said axle having drive members at opposite ends thereof mounted in respective ones of said tracks of said housing, said first motor operable to drive said axle to rotate said drive members in said tracks thereby moving said step assembly from said stowed position to said first deployed position and back; and
said second drive system includes a second motor coupled to a shaft, said shaft secured to said second step, said second motor operable to rotate said shaft thereby pivoting said second step from said first deployed position to said second deployed position and back.

11. The passenger access system of claim 10, further comprising a manual release mechanism normally engaged to said first drive system to couple said axle to said first motor, wherein said manual release mechanism is disengageable with said first drive system to uncouple said axle for rotation upon application of a manual force to said step assembly.

12. The passenger access system of claim 11, wherein said second step is also manually pivotable between said first deployed position and said second deployed position.

13. The passenger access system of claim 8, wherein said step assembly is sequentially deployed from said first deployed position to said second deployed position and back.

14. The passenger access system of claim 8, wherein:
said second step includes a second step member having a first tread surface and an opposite second tread surface; and
said first step includes a first step member having an upwardly oriented tread surface, wherein when said step assembly is in said first deployed position said first tread surface of said second step member is adjacent said tread surface of said first step member and said second tread surface is oriented upwardly, and when said step assembly is in said second deployed position said second tread surface of said second step member is oriented upwardly.

15. The passenger system of claim 14, wherein said step assembly is stowed in a housing with said first tread surface of said second step member adjacent said tread surface of said first step member.

16. The passenger system of claim 14, wherein said second step is pivotally coupled to an outboard end of said first step.

17. A passenger access system at an opening of a vehicle, comprising:
a pedestrian access system including a housing secured to the vehicle below the opening and a step assembly having a stowed position in said housing, said step assembly including a first step and a second step pivotally coupled to said first step, said step assembly having a first deployed position extending from said housing wherein said second step is supported on said first step, said step assembly further having a second deployed position wherein said second step extends from said first step away from the vehicle and is located below said first step.

18. The passenger access system of claim 17, wherein said pedestrian access system includes a first drive system for moving said step assembly to said first deployed position and a second drive system for moving said step assembly to said second deployed position.

19. The passenger access system of claim 18, wherein:
said first drive system includes a first motor coupled to an axle, said axle secured to said first step and said axle having drive members at opposite ends thereof mounted in respective ones of said tracks of said housing, said first motor operable to drive said axle to rotate said drive members in said tracks thereby moving said step assembly from said stowed position to said first deployed position and back; and
said second drive system includes a second motor coupled to a shaft, said shaft secured to said second step, said second motor operable to rotate said shaft thereby pivoting said second step from said first deployed position to said second deployed position and back.

20. The passenger access system of claim 19, wherein said second step is also manually pivotable between said first deployed position and said second deployed position.

21. The passenger access system of claim 19, wherein said step assembly is sequentially moved from said stowed position to said first deployed position to said second deployed position and back.

22. The passenger access system of claim 21, further comprising a manual release mechanism normally engaged to said first drive system to couple said axle to said first motor, wherein said manual release mechanism is disengageable with said first drive system to uncouple said axle for rotation upon application of a manual force to said step assembly.

23. The passenger access system of claim 17, wherein:
said second step includes a second step member having a first tread surface and an opposite second tread surface; and
said first step includes a first step member having an upwardly oriented tread surface, wherein when said step assembly is in said first deployed position said first tread surface is adjacent said tread surface of said first step member and said second tread surface is oriented upwardly, and when said step assembly is in said second deployed position said second tread surface of said second step member is oriented upwardly.

24. The passenger system of claim 23, wherein said step assembly is stowed in said housing with said first tread surface of said second step member adjacent said tread surface of said first step member.

25. The passenger system of claim 23, wherein said second step is pivotally coupled to an outboard end of said first step.

26. The passenger access system of claim 17, further comprising a wheelchair access system having a transfer member movable between a stowed position wherein the opening is substantially unobstructed and a deployed position wherein said transfer member extends from the vehicle at the opening, said pedestrian access system being mounted below said wheelchair access system and said step assembly being movable to said first and second deployed positions only if said transfer member is in said stowed position.

27. A passenger access system at an opening of a vehicle, comprising:
a pedestrian access system including a step assembly secured to the vehicle below the opening, said step assembly having a stowed position below the vehicle and said step assembly including a second step pivotally coupled to a first step, wherein:
said second step includes a second step member having a first tread surface and an opposite second tread surface;
said first step includes a first step member having an upper tread surface, wherein when in a first deployed position extending from the vehicle below the opening said first tread surface of said second step member is adjacent said tread surface of said first step member and said second tread surface is oriented upwardly, and further wherein when in a second deployed position extending from the vehicle said second tread surface of said second step member is oriented upwardly.

28. The passenger access system of claim 27, wherein said pedestrian access system includes a first drive system for moving said step assembly to said first deployed position and a second drive system for moving said step assembly to said second deployed position.

29. The passenger access system of claim 28, wherein:
said step assembly is stowed in a housing, said housing including a pair of opposite sidewalls each having a track therealong;
said first drive system includes a first motor coupled to an axle, said axle secured to said first step and said axle having drive wheels at opposite ends thereof mounted in respective ones of said tracks of said housing, said first motor operable to drive said axle to rotate said drive wheels in said tracks thereby moving said step assembly from said stowed position to said first deployed position and back; and
said second drive system includes a second motor coupled to a shaft, said shaft secured to said second step, said second motor operable to rotate said shaft thereby pivoting said second step from said first deployed position to said second deployed position and back.

30. The passenger access system of claim 29, wherein said second step is manually pivotable between said first deployed position and said second deployed position.

31. The passenger access system of claim 30, further comprising a manual release mechanism normally engaged to said first drive system to couple said axle to said first motor, wherein said manual release mechanism is disengageable with said first drive system to uncouple said axle for rotation upon application of a manual force to said step assembly.

32. The passenger access system of claim 27, wherein said step assembly is sequentially deployed from said stowed position to said first deployed position to said second deployed position and back.

33. The passenger system of claim 27, wherein said step assembly is stowed with said first tread surface of said second step member adjacent said tread surface of said first step member.

34. The passenger system of claim 27, wherein said second step is pivotally coupled to an outboard end of said first step.

35. The passenger access system of claim 27, further comprising a wheelchair access system having a transfer member movable between a stowed position wherein the opening is substantially unobstructed and a deployed position wherein said transfer member extends from the vehicle at the opening, said pedestrian access system being mounted below said wheelchair access system and said step assembly being movable to said first and second deployed positions only if said transfer member is in said stowed position.

36. A passenger access system for transferring one or more passengers between the ground and an opening of a vehicle, comprising:
a wheelchair access system mounted at the opening, the wheelchair access system having a transfer member movable between a stowed position wherein access to the opening is substantially unobstructed to a deployed position wherein the transfer member extends outwardly from the vehicle at the opening; and
a pedestrian access system including a step assembly mounted below said wheelchair lift, said step assembly having at least one step member movable between a stowed position below the vehicle to a deployed position extending outwardly from the vehicle, wherein said at least one step member cannot be moved from said stowed position to said deployed position when said transfer member is in its deployed position.

37. A passenger access system for transferring one or more passengers between the ground and an opening of a vehicle, comprising:
a wheelchair access system mounted at the opening, the wheelchair access system having a transfer member movable between a stowed position wherein access to the opening is substantially unobstructed to a deployed position wherein the transfer member extends outwardly from the vehicle at the opening;
a pedestrian access system including:
a housing mounted to the vehicle below said wheelchair access system;
a step assembly stowable in said housing and movable with respect thereto to a deployed position extending from the vehicle below the opening of the vehicle; and
a door pivotally mounted to a lower portion of said housing and coupled said step assembly, wherein said door has a substantially vertical position concealing said step assembly in said housing and as said step assembly is moved to said deployed position said door is pivoted to an open position below said step assembly.

38. The passenger access system of claim 34, wherein:
said step assembly includes a first step and a second step pivotally coupled to said first step; and
at least one linkage coupling said door to said first step.

39. A method for accessing a vehicle, comprising:
mounting a step assembly below an opening of the vehicle, the step assembly movable between a stowed position below the vehicle to a deployed position extending from the vehicle floor below the opening, the step assembly including a first step and a second step supported on the first step;
moving the step assembly to the deployed position; and
accessing the vehicle through the opening by stepping on the second step.

40. The method of claim 39, further comprising:
pivoting the second step about the first step to a second deployed position; and
accessing the vehicle through the opening by stepping on the second step and then stepping on the second step.

41. The method of claim 39, further comprising:
mounting a wheelchair access system at the opening of the vehicle; and
deploying a transfer member of the wheelchair access system to provide wheelchair access to the vehicle through the opening with the step assembly in the stowed position.

42. A method for accessing a vehicle, comprising:
mounting a step assembly below an opening of the vehicle
moving the step assembly to a first deployed position in a first automatic mode;
providing simultaneously a manual mode and a second automatic mode to move a second step of the step assembly relative to a first step of the step assembly to a second deployed position; and
moving the second step of the step assembly to the second deployed position in one of the manual mode and the second automatic mode.

43. The method of claim 42, further comprising:
moving the second step of the step assembly from the second deployed position to the first deployed position in one of the manual mode and the second automatic mode.

44. The method of claim 43, further comprising:
placing the step assembly in a manual mode; and
manually stowing the step assembly below the vehicle.

45. A passenger access system at an opening of a vehicle, comprising:
a pedestrian access system including a step assembly secured to the vehicle below the opening, said step assembly having a stowed position below the vehicle, said pedestrian access system including:
a first drive system moving said step assembly between a first deployed position and said stowed position in a first automatic mode; and
a second drive system simultaneously providing a second automatic mode and a manual mode for moving said step assembly between said first deployed position and a second deployed position.

46. The passenger access system of claim 45, wherein:
said step assembly includes a first step and second step stowed in a housing, said housing including a pair of opposite sidewalls each having a track therealong;
said first drive system includes a first motor coupled to an axle, said axle secured to said first step and said axle having drive members at opposite ends thereof mounted in respective ones of said tracks of said housing, said first motor operable to drive said axle to rotate said drive members in said tracks thereby moving said step assembly from said stowed position to said first deployed position and back in said first automatic mode; and
said second drive system includes a second motor coupled to a clutch sprocket engaged to a shaft, said shaft coupled to said second step, said second motor operable to rotate said shaft thereby pivoting said second step from said first deployed position to said second deployed position and back in said second automatic mode, said clutch sprocket allowing said second step to be pivoted from said first deployed position to said second deployed position and back in said manual mode.

47. The passenger access system of claim 45, further comprising means for switching said first drive system from said first automatic mode to a second manual mode and back.
